(19) United States
(12) Patent Application Publication
(10) Pub. No.: US 2003/0147999 A1
(43) Pub. Date: Aug. 7, 2003

(54) Cereal snack comprising a body of expanded and bonded cereal grains

(76) Inventors: Willy Mertens, Westerlo (BE); Paul Otten, Herentals (BE); Frieda Sporen, Houthalem (BE)

Correspondence Address: FULBRIGHT & JAWORSKI, LLP, 1301 MCKINNEY, SUITE 5100, HOUSTON, TX, 77010-3095, US

(21) Appl. No.: 10/204,929

(22) PCT Filed: Feb. 21, 2001
(86) PCT No.: PCT/IB01/00342

(30) Foreign Application Priority Data
Feb. 22, 2000 (GB) 0004177.2

(51) Int. Cl. A23G 3/00

(52) U.S. Cl. 426/94

(57) ABSTRACT

The invention provides cereal snack foods comprising a body of expanded and bonded cereal grains, wherein the cereal grains have been flattened by rolling prior to expansion. The cereal grains may be rice grains. The invention also provides a process for the production of such snack foods, the process comprising the steps of: providing a plurality of cereal grains having a moisture content sufficiently high to render the grains plastic; compressing the cereal grains to flatten the grains; where necessary drying and/or rehydrating the flattened cereal grains to a moisture content of from about 10% by weight to about 20% by weight; introducing the dried cereal grains into a mold; and applying heat and pressure to puff and bond the dried cereal grains in the mold to form the body.

### FIELD OF THE INVENTION

The present invention relates to snack foods comprising a body of expanded and bonded cereal grains, and to improved processes for the manufacture thereof.

### BACKGROUND OF THE INVENTION

It is known to produce snack foods comprising a body of expanded and bonded cereal grains. For example, rice cakes are commercially available products formed from puffed rice grains that are bonded together by heat and pressure, without the use of a binder. The rice cakes have low density and low moisture content, and are typically the shape and size of a cookie or rusk. Similar puffed (also known as expanded) cereal cakes can be made with many other cereal grains including (but not limited to) wheat, millet, buckwheat, barley or corn.

Rice cakes are currently made by a process comprising the steps of: (1) providing a mold comprising a plurality of mold elements including a reciprocally moveable piston element for compressing rice gains inside the mold; (2) introducing a predetermined quantity of unpuffed rice to the mold, the average moisture content of this rice being from 12 to 17% by weight; (3) compressing the rice grains in the mold at from 3 MPa to 15 MPa (30 to 150 bar) pressure; (4) heating the rice grains in the mold to a temperature of 170-320° C.; (5) moving the piston element to expand the mold by a predetermined amount, whereupon the heated rice grains expand and bond to form the rice cake, followed by (6) removing the finished rice cake from the mold.

Typically, the steps of heating, compressing and expanding the mold are carried out substantially concurrently in a suitably adapted mold apparatus that can provide high pressures and temperatures, together with precisely controlled expansion of the mold in the puffing step. Such rice puffing molds are described in a number of patent specifications, including U.S. Pat. Nos. 4,281,593 and 4,667,588, the entire contents of which are expressly incorporated herein by reference.

Expanded rice cakes are attractive as snack foods to health-conscious consumers because of their low fat content. The fat content of a rice cake is of the order of 0.5% by weight. This compares with 30-40% by weight fat content for a normal potato chip. Even the “reduced fat” potato chips that are now appearing on the market contain 20-25% by weight of fat. Other low-fat snack foods rely on the use of fat substitutes such as OLESTRA (Registered Trade Mark), which present regulatory and other difficulties.

A disadvantage of currently known rice cakes is that they have a very dry mouth feel, which reduces their consumer acceptability and reduces the rate at which they can be consumed. The problem of dry mouth feel is especially severe for savory flavored snacks.

U.S. Pat. No. 4,888,180 describes the formation of expanded cereal cakes, in particular rice cakes. The process comprises a preliminary step of steaming the rice grains to a moisture content of 18 to 25% to at least partially gelatinize the starch in the grains, followed by drying the grains to a moisture content below about 18% and puffing the grains under pressure to form rice cakes in conventional fashion. The resulting cakes are said to be less fragile than those made from ungelatinized rice. There is no disclosure of rolling the hydrated rice grains to flatten the grains before puffing.

It is an object of the present invention to provide improved snack foods for both human and animal consumption based on expanded cereal cakes having greatly improved texture and mouth feel compared to previously known cereal cake products.

It is a further object of the present invention to provide processes for the production of such improved expanded cereal cakes.

### DETAILED DESCRIPTION OF PREFERRED EMBODIMENT

In a first aspect, the present invention provides a cereal snack comprising a body of expanded and bonded cereal grains, wherein the cereal grains have been flattened by rolling prior to forming the expanded and bonded body.

The cereal snack may consist essentially of the body of expanded and bonded cereal grains, or it may further comprise a coating of a flavoring material or a functional material on the said body. Suitable flavoring materials include sweet coatings such as sugar coatings or chocolate coatings. Alternatively, the coating may comprise a savory flavoring material, such as salt, cheese powder, barbeque flavor, mesquite flavor, chilli powder, and the like. Suitable functional coatings include vitamins, minerals, amino acids and the like.

The body of expanded and bonded cereal grains may form the core of the snack food according to the present invention. The body is formed by the simultaneous expansion and bonding together of the cereal grains at elevated temperature and pressure, resulting in direct bonding between the expanded grains as in a conventional expanded cereal cake. In certain embodiments, the body of the snack consists essentially of said expanded and bonded cereal grains. In other embodiments, flavoring or coloring agents may also be present in the core. Additional food ingredients such as flavoring agents, lipids, sugars or dietary supplements such as vitamins and minerals may also have been infused into the cereal grains before the expansion step, as described in our copending European patent application no. 99309734.4.

In certain embodiments, the body of expanded and bonded cereal grains is substantially round, oval or polygonal. The body may alternatively have a fancy shape, such as a dog bone shape for a pet food snack.

The body of expanded and bonded cereal grains may be a disk or flat wafer shape having substantially flat upper and lower surfaces. It is a particular advantage of the present invention that it enables very thin expanded cereal snack wafers to be made having good structural integrity. Preferably, the thin wafers have a thickness of from 1 to 5 mm.

In other embodiments the top surface and/or the bottom surface of the snack body is non-flat, for example it may be in the shape of a cup, or is saddle-shaped, or wave-shaped or some intermediate shape therebetween. The surface of the body may be slightly rough and granular, but generally less so than for conventionally known rice cakes.

The shape of the snack body may be somewhat irregular. Preferably, the body of expanded and bonded cereal grains is generally in the form of a chip having a mean diameter of from 20 mm to 150 mm, preferably of from about 20 mm to about 45 mm and a mean thickness of from 1 to 15 mm, preferably of from about 1 mm to about 8 mm. More preferably, the mean thickness is in the range of 2 mm to 5 mm. The volume of the snack body may be in the range 1 cm³ to 10 cm³, preferably 2 cm³ to 6 cm³, as determined by the conventional particle displacement method used for bakery goods.

The cereal grains may be any starchy grains suitable for forming a puffed cereal cake including (but not limited to) rice, wheat, millet, buckwheat, barley, corn, and mixtures thereof. Preferably, the cereal grains comprise rice, and more preferably they consist essentially of rice. Long grain rice varieties are preferred. The grains may be whole grains or partially milled grains, for example so-called brown rice. Preferably, the cereal grains are milled grains, i.e. grains from which the bran (pericarp) has been removed by milling to leave the starchy endosperm.

The cereal grains may be whole grains, or they may be broken grains. The term “grains” in this specification refers to whole or broken natural starchy endosperms. Powdered, reconstituted or extruded starch pieces may optionally be included as a minor constituent of the cereal core in addition to the whole or broken grains.

The cereal grains have been flattened by compression prior to expansion and bonding. That is to say, the grains while in a plastic state have been passed through a roller gap that is sufficiently small to permanently deform them before introduction into the cereal cake puffing machine. The compression results in a disruption of the cellular and starch granule structure of the grains, with surprising consequences for the finished cereal cake products.

It has been found that cereal cakes according to the present invention have a much pleasanter and less dry mouth feel than cereal cakes made in identical fashion, but without rolling of the cereal grains before puffing. Furthermore, the crispness of the cereal cakes is actually improved relative to the cakes made with non-rolled grains. The texture and porosity of the cereal cores is also improved in the snacks according to the present invention. These improved properties are achieved without any loss of integrity or taste.

The improved mouth feel of the cereal cores is reflected in their more rapid uptake of water from a humidified atmosphere as measured by the procedure described below. Preferably, the body of the snack has an equilibrium moisture uptake after 60 minutes at 30° C. and 90% relative humidity of at least 10% by weight based on the weight of the dry snack body, more preferably at least 12% by weight.

The body of the snack preferably has a bulk density as determined by a particle displacement method of from about 0.11 to 0.23 g/cm³, more preferably about 0.13 to 0.21 g/cm³, and most preferably from 0.15 to 0.19 g/cm³.

It is a particular advantage of the snack foods according to the present invention that they provide a pleasant mouth feel without high fat (lipid). In many embodiments, the cereal snack according to the present invention comprises less that 20% by weight of fat, preferably less than 10% by weight of fat, and more preferably less than 5% by weight of fat. In certain preferred embodiments of the invention, the fat content is less than 3% by weight, thereby qualifying the snack food to be sold as a “low fat” product under current regulatory provisions in Europe.

In a second aspect, the present invention provides a process for the preparation of a cereal snack comprising a body of expanded and bonded cereal grains, said process comprising the steps of:

providing a plurality of cereal grains;

compressing said cereal grains to flatten the grains;

where necessary drying and/or rehydrating said flattened cereal grains to a moisture content of from about 10% by weight to about 20% by weight; followed by

introducing said flattened cereal grains into a mold;

applying heat and pressure to said flattened cereal grains in said mold; and

expanding said mold to allow said cereal grains to expand to form said body.

The cereal grains are normally provided at a moisture content and temperature at which the grains are at least somewhat plastic, whereby compressing the grains results in plastic deformation to flatten the grains substantially without shattering the grains. The plurality of cereal grains preferably has a moisture content preferably in the range of from about 18% by weight to about 30% by weight when fed to the compressing step.

In certain embodiments, the plurality of grains consists essentially of parboiled grains. Parboiling is the name given to the treatment of raw cereal grains with water or steam and heat to substantially gelatinise the starchy endosperm of the grains. The grains are then normally dried to a moisture content below about 16% resulting in a glassy, pregelatinised starchy endosperm. Parboiled grains may, for example, be rehydrated and tempered to render them sufficiently plastic for deformation by compression.

It is also possible to interrupt the drying process following the initial gelatinisation step to provide partially dried grains having a moisture content of 18 to 30% by weight. The starchy endosperm of such incompletely dried parboiled grains is still soft, somewhat resilient, but capable of plastic deformation. Such partially dried parboiled grains are especially suitable for rolling in the process of the present invention, and have been found to produce surprisingly better rice cakes than rehydrated parboiled grains.

Parboiling is conventionally carried out on grains having both the bran and the outer husk attached thereto (e.g. so-called paddy rice). However, it has been found by the present inventors that substantially improved flavor properties are achieved in the final expanded cereal products if the parboiling is carried out on grains that have been hulled to remove the husk therefrom, but not milled (e.g. so-called brown or cargo rice).

Accordingly, the step of providing in the process according to the present invention preferably comprises the step of treating raw hulled cereal grains with water or steam at a temperature and for a time sufficient to substantially gelatinize the starch in the grains, wherein the raw hulled grains are substantially unmilled.

The treated grains will normally have a moisture content above 30% by weight, in which case the grains are then dried. Preferably a partial drying to a moisture content of 18-30% by weight, more preferably 20-25% by weight is carried out. In certain preferred embodiments the partially dried grains are milled at the elevated moisture content of 18 to 30% to remove at least a portion of the bran therefrom prior to the compressing step. The techniques of milling at elevated moisture contents are described in detail in WO97/49300. Cereal products milled in this way have unique properties that render them especially suitable for use in the processes of the present invention.

Preferably, the treated and optionally milled grains are fed to the step of compressing substantially without intermediate drying to a moisture content below 18%. This reduces the amount of energy needed, and has also been found to give an improved product.

Preferably, the step of compressing reduces the average thickness of the grains to from about 90% to about 10% of the average thickness before compressing, more preferably from 50% to 90% so as to preserve the free-flowing nature of the grains. In certain embodiments, for example in the compression of long grain rice, the step of compressing preferably reduces the average thickness of the grains from a mean of about 1.6 mm to from about 0.2 mm to about 1.4 mm, more preferably to 1.0 mm to 1.4 mm. The temperature of the compressing step is preferably in the range of from about 10° C. to about 100° C., typically from 25° C. to 60° C. Preferably, the compressing is carried out by rolling.

For example, rice grains may be compressed at 24% moisture content and about 40° C., for example by passing through smooth rollers that are pressed together by a predetermined spring loading to produce flattened rice kernels having a thickness of about 1.2 mm depending on the rice flow rate (the starchy grains remain somewhat resilient at this moisture content and temperature).

The step of compressing is followed where necessary by steps of drying and/or rehydration. The drying may be needed to produce an intermediate product that is storage stable, or to reduce the moisture content to the optimum range for puffing, which is thought to be about 12 to 18% moisture content by weight. The rehydration step may be needed in order to rehydrate an intermediate storage stable product, or to achieve a desired moisture gradient such that the moisture content near the surface of the grains is higher than the moisture content in the center of the grains. This is thought to result in expanded products having better physical properties. Both the drying step and the rehydration step may be combined with a tempering step in order to achieve the desired moisture content gradient in the grains.

In certain preferred embodiments, the grains are compressed at about 18 to 25% moisture content, then dried to about 12-14% moisture content, then rehydrated to up to 16% moisture content (all percentages by weight) and finally tempered at ambient temperature for from 1 to 3 hours.

The steps of loading, compressing, heating and expanding the flattened cereal grains into cereal cakes is carried out in substantially conventional fashion as described in the above-referenced patent publications. For example, the steps may be carried out with heating at a temperature of from about 170° C. to about 320° C. with a cycle time of from about 1 to about 20 seconds, preferably about 5 to 10 seconds. It is thought that the initial step of compressing and heating achieves bonding between the compressed grains in their hot, plastic state. The expansion of the mold then allows the bonded grains to expand to form the expanded bonded cereal body.

It is a particular advantage of the present invention that the flattened cereal grains have improved expansion properties, possibly in part due to faster thermal conduction into the flattened grains. This permits excellent expansion to be achieved with a shorter cycle time, and in particular with a shorter heating/compressing stage of the cycle. As well as improving throughput, the shorter heating stage results in less carbonisation of the mold and hence less machine down time for cleaning.

It has also been found that the flattened cereal grains are especially suitable for forming extremely thin cereal bodies that are substantially free from holes, gaps or regions of weakness. This may be because the flattened grains can plasticise and flow more readily under the influence of heat and pressure to form a uniform body in the mold. It enables the grains to be dosed to the mold at extremely low densities, for example from about 0.03 g of grains per cm² of mold area to about 0.1 g of grains per cm² of mold area, preferably from about 0.04 g/cm² to 0.07 g/cm². Consequently, the expanded grain bodies preferably have a weight per unit area of from about 0.03 g/cm² to about 0.1 g/cm², more preferably from about 0.04 g/cm² to about 0.08 g/cm².

The expanded cereal core bodies can be coated with flavoring agents in conventional fashion, for example by a rotating pan coater, a rotating disc spray coater, or other methods well known in the art.

In certain preferred embodiments of the present invention, the method further comprises the step of infusing an additional food ingredient into the grains prior to the puffing step by treating the grains with the food ingredient dissolved or dispersed in water. The food ingredient is preferably selected from the group consisting of sugars, flavoring agents, dietary supplements and mixtures thereof. Suitable methods are described in our copending European patent application no. 99309734.4.

Specific embodiments of the present invention will now be described further with reference to the following examples and the accompanying drawings, in which:

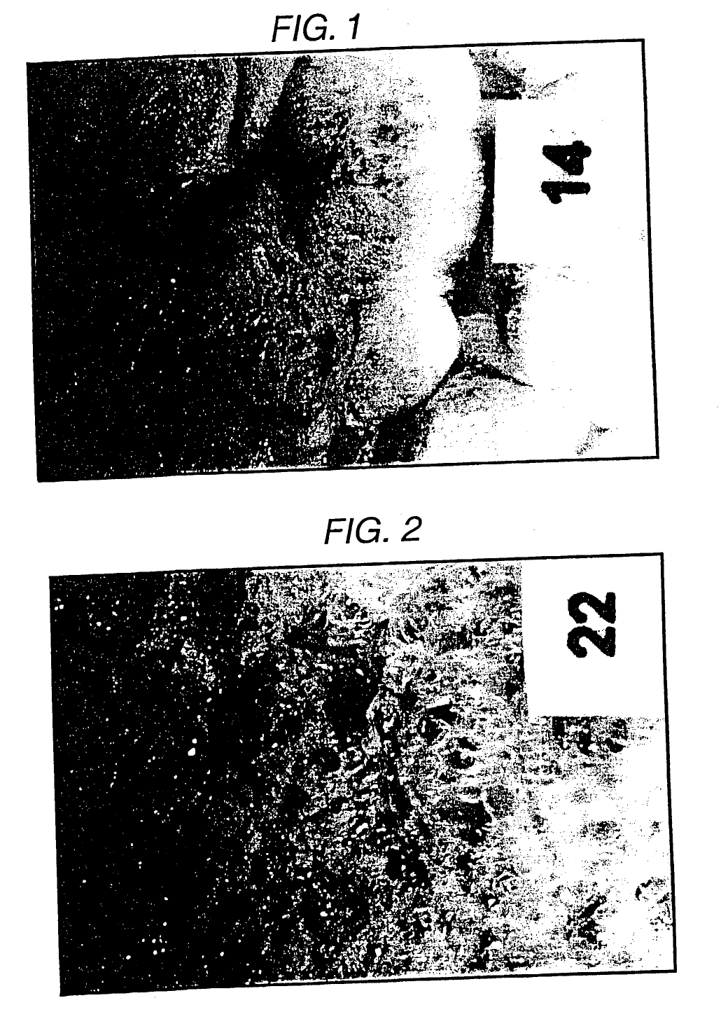

FIG. 1 shows a photomicrograph at approximately 15×magnification of a comparative expanded rice core made in accordance with Example 1;

FIG. 2 shows a photomicrograph at approximately 15×magnification of an expanded rice cake core for a snack food according to the present invention, made in accordance with Example 2; and

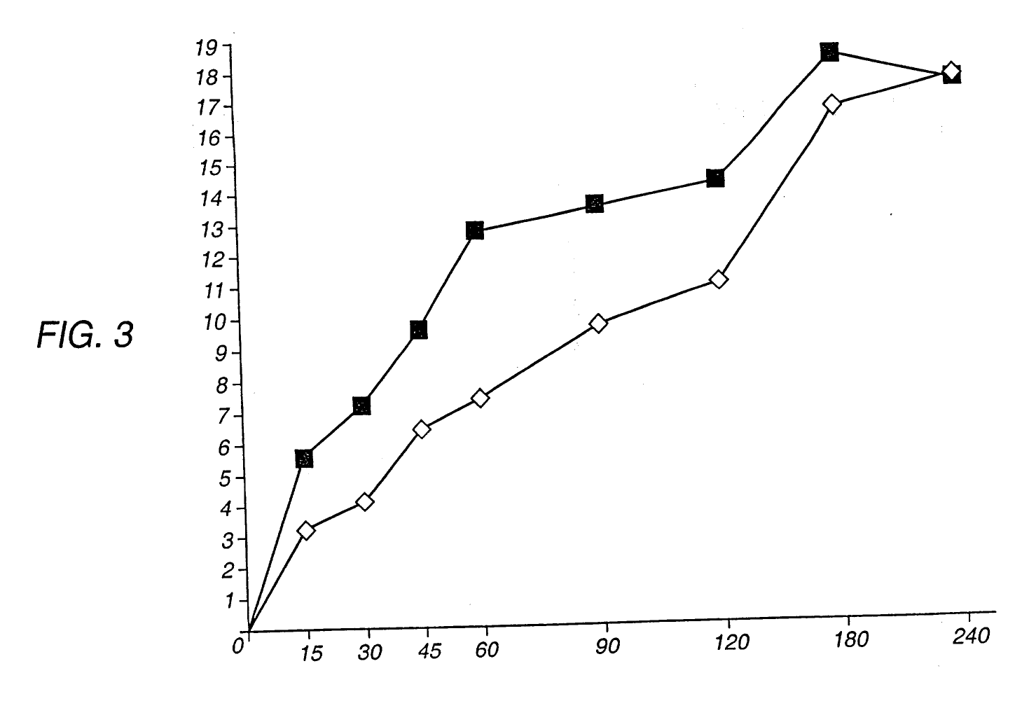

FIG. 3 shows a graph of percentage weight increase against time for the expanded rice cores of Examples 1 (open squares) and 2 (solid squares) when placed in a humidified atmosphere for the determination of equilibrium moisture content.

In examples 1 and 2, a tasting panel assessed the following characteristics of the cereal cakes: hardness, mouth drying, crispness, graininess (grittiness), time release of flavor, duration of flavor, irregularity and color. Quantitative measurements were carried out to evaluate density and texture, as detailed further below.

### EXAMPLE 1

### Comparitive

A conventional rice cake containing no flattened rice grains was prepared as follows.

A sample of rice was parboiled as described in the examples of U.S. Pat. No. 5,130,153. Briefly, the parboiling was carried out as follows. A 500 kg sample of the rice, from which the husks, but not the bran, had been removed was fed into a hot steeper bath containing water at 71° C. The residence time of the rice in the water was 4.5 minutes. During transit through the steeper, the moisture of the rice was raised to 25%.

The rice was then transported to a dewatering belt to remove surface water from the rice. The residence time of the rice on the belt was between 30-60 seconds. The rice was fed from the belt directly into a steamer, in which steam at 106° C. and about 0.20 bar overpressure was applied to the rice. The residence time of the rice in the steamer was 30 minutes. During its transit through the steamer, the moisture of the rice was raised to about 28% and its temperature was raised to 106° C.

The steamed rice was then fed into a continuous microwave unit operating at 133 to 136° C. and an overpressure of about 3.5 bar. The residence time of the rice in the microwave unit was 4 minutes. During its residence time in the microwave unit, the starch in the rice grains was fully gelatinized.

The rice was then passed to a pressure reduction system, wherein the pressure on the rice was released in 2-3 steps over a period of 1 to 6 minutes. During this time, the temperature of the rice fell to about 100° C., its moisture was reduced to about 25% and the pressure fell to atmospheric pressure. The rice was then partially dried, cooled to about 35° C. and milled at 19-24% moisture content in three stages in a vertical rice mill with intermediate rehydration steps to remove the bran therefrom. The rice was then further dried in a conventional grain dryer to 13% by weight moisture content.

During the milling process, some of the rice kernels were broken into smaller pieces by the action of the mills. This broken rice was sorted from whole kernel rice by various methods known to those skilled in the art. The broken rice sorted from this process was used as the base cereal ingredient for expanded rice cakes, as follows.

1000 grams of the broken rice at a moisture content of 12.9% was blended with 25 grams of water in a mixing bowl by hand for approximately 5 minutes (until the mixture was free-flowing). This rice was then put into a sealed container at room temperature for 2 hours for the moisture to equilibrate. Once equilibrated, the rice was fed into an Incomec Cerex-21-MI rice cake machine (Bramecon n.v.; Brakel, Belgium). The puffing conditions used for a 4.5 cm diameter mold containing 2 g of the rice were: 8-10 Mpa hydraulic pressure, 7 seconds heating and compression time prior to expansion, and 275° C. temperature. These conditions were found, through discussions with the equipment manufacturer and by experience, to be the best conditions for producing consistently strong, good quality rice cakes.

The resulting rice cakes have a diameter of about 45 mm, a thickness of about 8 mm and a bulk density of about 0.183 g/cm³ with a standard deviation of 0.013 g/cm³. The volume of the snacks was 11 cm³ with a standard deviation of 0.41 cm³ It can be seen from FIG. 1 that the rice cakes have a non-uniform porosity, with a granular structure consisting of distinct expanded rice kernels bonded together being clearly visible. It can be seen from FIG. 3 that the rice cakes take up moisture from a humidified atmosphere relatively slowly and approach the equilibrium moisture content only after about 200 minutes.

The fat content of the rice cakes is only about 0.5% by weight. Unfortunately, the rice cakes have a dry, “tooth-sticking” mouth feel that is especially apparent with savory flavor coatings, such as salt. Furthermore, the texture of the rice cakes is non-uniform and slightly chewy instead of perfectly crisp. These texture properties are also apparent from the texture analysis measurement described below, which gave a value of 1132 g with a high standard deviation of 506 g.

### EXAMPLE 2

The method of Example 1 was repeated, but with an intermediate compression step carried out on the debranned rice exiting from the mill at 24% moisture content and about 40° C. This rice is passed through rollers spaced at 0.05 mm at near-ambient temperature. The rice undergoes plastic deformation substantially without fragmentation to give flattened grains approximately 0.2 mm thick. The flattened grains are then dried to about 12-17% moisture content, preferably about 13% moisture content, and puffed into cakes as described in Example 1.

The resulting rice cakes have good colour and crispness. The improved crispness and uniformity of the rice cakes is reflected in the texture analysis measurement detailed below. This gave a value of 762 g, with a standard deviation of only 188 g. The rice cakes have a diameter of about 45 mm, a thickness of about 2 mm and a bulk density of 0.169 g/cm³ with a standard deviation of 0.022 g/cm³. By adjusting the parameters of the puffing machine it is possible to make non-planar rice cakes in dish, saddle, wave and intermediate shapes.

The fat content of the rice cakes is about 0.5% by weight. The appearance of the rice cakes is different from that of the rice cakes of Example 1, as can be seen from a comparison of FIGS. 1 and 2. These show that the structure of the rice cakes of Example 2 are less obviously granular the rice cakes of Example 1. The rice cakes of Example 2 have a more uniform porosity, with individual expanded rice kernels being less obviously present.

The rice cakes of Example 2 have a notably pleasant texture and have a very much less dry mouth feel than the cakes of Example 1. This is especially apparent with savory flavor coatings, such as salt. It seems that the rolling step has resulted in a change in the cellular structure or starch granule structure of the grains, and this has had a surprisingly large impact on the degree of expansion, structure and properties of the rice cake product.

The thermal properties of the expanded rice cakes made in accordance with this example were studied by differential scanning calorimetry (DSC). The results showed complete absence of a starch gelatinization peak. There was a small endotherm (about 0.5 mJ/mg) at about 110° C., which is thought to be due to the presence of amylose-lipid complexes.

The properties of the rice cakes were also studied by rapid viscoanalysis (RVA) on a 10% by weight dispersion of powdered rice cake in water using a temperature profile of: 5° C./min ramp up to 95° C.; hold at 95° C. for 5 minutes; ramp down 5° C./min to 50° C.; hold at 50° C. for 5 minutes. The results show marked differences between the viscosity vs. time plots for the rice cakes of Example 2 as compared with the rice cakes of Example 1.

### EXAMPLE 3

The method of Example 2 was repeated, but with the intermediate compression step carried out on the debranned rice exiting from the mill at about 22% moisture content and about 40° C. This rice is passed through rollers spring-loaded in compression at near-ambient temperature. The rice undergoes plastic deformation substantially without fragmentation to give flattened grains approximately 1.2 to 1.4 mm thick. The thickness of the flattened grains is determined by the rate of flow of the rice through the rollers and the compression force on the rollers. The less flattened grains are more free-flowing than the highly flattened grains of Example 2, while still giving excellent properties in the product. The flattened grains are then dried to about 13% moisture content, and then are rehydrated to 14.5% moisture content by stirring in a water spray for 20 minutes at ambient temperature. The rehydrated grains are allowed to stand at ambient temperature for 2 hours to achieve the optimum moisture gradient.

About 1.2 g of the grains are loaded into each 4.5 cm diameter mold. The grains are puffed into rice cakes with heating at about 270° C., pressure at about 4.1 MPa at the mold face, and a cycle time of 5-10 seconds. The details of the expansion process are adapted by trial and error to produce the optimum rice cake.

The resulting rice cake has a very thin, crisp structure with a pleasant mouth feel and mild cereal taste. It can be consumed directly, in which case it contains less than 0.5% dietary fat.

Procedure 1 (Density Determination)

The volume and bulk density of the expanded cereal cake cores were determined by a displacement method, wherein the material being displaced consisted of glass microspheres. Eight measurements were carried out on different cores to obtain mean values and standard deviation. The results were as follows:

| | | |
|---|---|---|
| Cores of | mean volume 11.0 cm³ | Standard deviation 0.41 |
| Example 1: | mean density 0.183 g/cm³ | Standard deviation 0.013 |
| Cores of | mean volume 8.62 cm³ | Standard deviation 0.51 |
| Example 2: | mean density 0.169 g/cm³ | Standard deviation 0.022 |

Procedure 2 (Texture Analysis)

The texture of the expanded cereal cakes was assessed using a TA-XT2 analyzer. In this device, a 2.5 mm diameter cylinder is pushed 2 mm into the rice cake with a speed of 0.2 mm/sec. The force required in grams is measured as a function of distance in mm. The maximum force values were determined for five rice cracker samples, and mean values and standard deviations of these maxima were calculated. The mean maximum force values were as follows:

| | | |
|---|---|---|
| Cores of Example 1: | 1132 g | Standard deviation 506 |
| Cores of Example 2: | 762 g | Standard deviation 188 |

Procedure 3 (Moisture Uptake Studies)

Expanded snack cores were weighed individually and then put in a climate controlled cabinet at 90% relative humidity and 30 ° C. The samples were weighed at intervals of from 15 minutes to 4 hours to obtain the data shown in FIG. 3.

The above examples have been described for the purpose of illustration only. Many other examples falling within the scope of the accompanying claims will be apparent to the skilled reader. One skilled in the art will readily appreciate that the present invention is well adapted to carry out the objects and obtain the ends and advantages mentioned as well as those inherent therein. The snack foods, methods, processes and procedures described herein are presently representative of the preferred embodiments are exemplary and are not intended as limitations on the scope of the invention. Changes therein and other procedures and uses will occur to those skilled in the art which are encompassed within the spirit of the invention and are defined by the scope of the claims.

All patents and publications mentioned in this specification are indicative of the level of those skilled in the art to which the invention pertains. All patents, publications herein are incorporated by reference to the same extent as if each individual publication was specifically and individually indicated to be incorporated by reference.

What is claimed is:

1. A cereal snack comprising a body of expanded and bonded cereal grains, wherein the cereal grains have been flattened by rolling prior to expansion.

2. A cereal snack according to claim 1, further comprising a coating of a flavoring material or a functional material on said body.

3. A cereal snack according to claim 2, wherein said coating comprises a savory flavoring material.

4. A cereal snack according to claim 2, wherein said coating comprises a sweet flavoring material.

5. A cereal snack according to any preceding claim, wherein the body of the snack is in the form of a chip having a mean diameter of from about 20 mm to about 45 mm and a mean thickness of from about 1 mm to about 8 mm.

6. A cereal snack according to any preceding claim, wherein the body of the snack is substantially round, oval or polygonal.

7. A cereal snack according to any one of claims 1 to 5, wherein the body of the snack has a fancy shape.

8. A cereal snack according to any preceding claim, wherein the body of the snack has substantially flat and parallel upper and lower surfaces.

9. A cereal snack according to claim 8, wherein the body of the snack has a thickness of from 1 to 5 mm.

10. A cereal snack according to any one of claims 1 to 7, wherein the top surface and/or the bottom surface of the snack body is cup shaped, wave shaped or saddle shaped.

11. A cereal snack according to any preceding claim, wherein said body of the snack has a volume as determined by a particle displacement method of from about 1 cm³to about 10 cm³.

12. A cereal snack according to any preceding claim, wherein said body of the snack has a weight per unit area of from about 0.03g/cm² to about 1 g/cm².

13. A cereal snack according to any preceding claim, wherein said body of the snack has an equilibrium moisture uptake after 60 minutes at 30° C. and 90% relative humidity of at least 10% by weight based on the weight of the dry snack body.

14. A cereal snack according to any preceding claim, wherein the said body of the snack consists essentially of said expanded and bonded cereal grains.

15. A cereal snack according to any preceding claim, wherein the cereal grains consist essentially of whole or broken rice grains.

16. A cereal snack according to any preceding claim, wherein the snack comprises less than 20% by weight of fat.

17. A cereal snack according to claim 16, wherein the snack comprises less than 10% by weight of fat.

18. A cereal snack according to claim 17, wherein the snack comprises less that 5% by weight of fat.

19. A cereal snack according to claim 18, wherein the snack comprises less than 3% by weight of fat.

20. A cereal snack according to any preceding claim, wherein an additional food ingredient has been infused into the cereal grains prior to expansion.

21. A cereal snack according to claim 20, wherein the additional food ingredient is selected from the group consisting of sugars, flavoring agents, dietary supplements and mixtures thereof.

22. A process for the preparation of a cereal snack comprising a body of expanded and bonded cereal grains, said process comprising the steps of:
providing a plurality of cereal grains;
compressing said cereal grains to flatten the grains;
where necessary drying and/or rehydrating said flattened cereal grains to a moisture content of from about 10% by weight to about 20% by weight; followed by
introducing said flattened cereal grains into a mold;
applying heat and pressure to said flattened cereal grains in said mold; and
expanding said mold to allow said cereal grains to expand to form said body.

23. A process according to claim 22, wherein said plurality of cereal grains fed to said step of compressing has a moisture content in the range of from 18% by weight to 30% by weight.

24. A process according to claim 22 or 23, wherein said grains consist essentially of whole or broken kernels of long grain rice, and said step of compressing reduces the average thickness of the grains to a mean of from about 0.2 mm to about 1.4 mm.

25. A process according to claim 22, 23 or 24, wherein said step of compressing reduces the average thickness of the grains to from 90% to 25% of the average thickness before compressing.

26. A process according to any one of claims 22 to 25, wherein said step of compressing is carried out at a temperature of from 10 to 100° C.

27. A process according to any one of claims 22 to 26, wherein said plurality of grains consist essentially of parboiled grains.

28. A process according to any one of claims 22 to 27, wherein said step of providing a plurality of cereal grains comprises the steps of: treating raw hulled cereal grains with water or steam at a temperature and for a time sufficient to substantially gelatinize the starch in the grains, wherein said raw hulled grains are substantially unmilled.

29. A process according to claim 28, wherein the step of treating is followed by adjusting the moisture content of the grains to a range of from about 18% to about 30% by weight and milling the grains at said moisture content of from about 18% to about 30% by weight to remove at least a part of the bran therefrom.

30. A process according to claim 28 or 29, wherein the treated and optionally milled grains are fed to the step of compressing substantially without intermediate drying to a moisture content below 18%.

31. A process according to any one of claims 22 to 30, wherein following said step of compressing, the flattened grains are dried to a moisture content of about 12 to about 14% and are then rehydrated to a moisture content of up to about 16%, optionally with tempering, before the grains are introduced into the mold.

32. A process according to any one of claims 22 to 31, wherein the step of heating is carried out at a mold temperature of from about 170° C. to about 320° C., and molding cycle time is from about 1 to about 20 seconds.

33. A process according to any one of claims 22 to 32, further comprising the step of infusing an additional food ingredient into the grains prior to the grains are introduced into the mold by treating the grains with the food ingredient dissolved or dispersed in water.
